(19) United States
(12) Patent Application Publication
(10) Pub. No.: US 2010/0276819 A1
(43) Pub. Date: Nov. 4, 2010

(54) Microbubble gas-liquid mixing device

(76) Inventor: Min Chien Teng, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,540

(22) Filed: Apr. 1, 2008

(51) Int. Cl. B01F 3/04

(52) U.S. Cl. 261/31

(57) ABSTRACT

A microbubble gas-liquid mixing device is fitted and disposed in a sanitary fixture, wherein the sanitary fixture has at least one faucet and the water source treated by the microbubble gas-liquid mixing device is introduced into the faucet. The microbubble gas-liquid mixing device comprises a pump and a spiral tube, and air enters the pump and spiral tube through a first gas inlet valve disposed at the front end of the pump and is therein mixed with the water source in a gas-liquid phase to form a large amount of fine bubbles, thereby achieving the effect of increasing the oxygen content in water.

### BACKGROUND OF THE INVENTION

(a) Field of the Invention

The present invention relates to a water-treating device, and more particularly, to a microbubble gas-liquid mixing device, which can increase the oxygen content in water and enable the air in water to form fine bubbles outputted together with the water source.

(b) Description of the Prior Art

There is a microbubble water-treating device 9 of the prior art, as shown in FIG. 6, which is mainly composed of a motor 91, a pressure tank 92 and a high oxygen dissolving mechanism 93. The motor 91 pressurizes water to flow through a first flow channel and reach the pressure tank 92. The first flow channel 94 is provided with an air valve 95 to supply air into the first flow channel 94 and the air will flow to the pressure tank 92 together with the water stream. At this time, the air and the water stored in the pressure tank 92 will be acted by the high pressure such that the air is dissolved and forms bubbles in the water.

The foregoing high oxygen dissolving mechanism 93 communicates with the pressure tank 92 via a second flow channel 94. The inner flow channel of the high oxygen dissolving mechanism 93 is designed to change the water flow velocity and reduce the size of the bubbles dissolved in water.

However, although the foregoing microbubble water-treating device 9 can increase the dissolved oxygen content in water, the members of the microbubble water-treating device 9 are complicated and it is necessary to achieve the effect of high dissolved oxygen content by means of the pressure tank 92 in coordination with the high oxygen dissolving mechanism 93. Also, the effect is quite limited due to the primary intake air and high pressure oxygen dissolving. As a result, there is a need for an improved device.

### SUMMARY OF THE INVENTION

The primary objective of the present invention that has been made to solve the aforementioned problems is to provide a microbubble gas-liquid mixing device, in which air is dissolved into water and forms a large amount of fine bubbles by the arrangement of the spiral tube, the intake air of the gas inlet valve and the pressurization of the pump.

To achieve the above objective, the present invention provides a microbubble gas-liquid mixing device, which is fitted and disposed in a sanitary fixture, wherein the sanitary fixture has at least one faucet and the water source treated by the microbubble gas-liquid mixing device is introduced into the faucet, characterized in that:

The microbubble gas-liquid mixing device comprises at least one pump, wherein the pump has a water inlet end and a water outlet end, and the water inlet end communicates with the water outlet end, and at least a first gas inlet valve is disposed at the water inlet end and the water outlet end communicates with a water supply channel, and air is introduced by means of the first gas inlet valve and enters the pump such that the pump pressurizes the air and the water source for gas-liquid mixing and then transports the mixture from the water outlet end to the water supply channel; and a spiral tube, which communicates with the water supply channel such that the gas-liquid mixed water source contained in the water supply channel flows into the spiral tube for gas-liquid mixing once again allowing the air and the water source to swirl and mix within the spiral tube and to output the oxygen-rich water source from the spiral tube.

Moreover, according to the present invention, a regulating valve is additionally disposed in the water supply channel to regulate the water flow capacity from the water supply channel to the spiral tube and simultaneously regulate the outlet water pressure from the water supply channel to the spiral tube.

Furthermore, according to the present invention, the gas-liquid mixing device is further provided with a gas-liquid mixing tank, and the gas-liquid mixing tank is provided with a gate valve seat to form an enclosed space within the gas-liquid mixing tank and the spiral tube is disposed in the enclosed space, and the gate valve seat has a water inlet portion and a water outlet portion, and the water inlet portion communicates with the water supply channel and the spiral tube. The spiral tube is further provided with a high-pressure water outlet to eject the second gas-liquid mixed water source from the high-pressure water outlet and perform the third gas-liquid mixing in the enclosed space.

In addition, the gas-liquid mixing tank is further provided with a second gas inlet valve, and air is introduced by means of the second gas inlet valve for the second time and perform the fourth gas-liquid mixing in the enclosed space.

There are a plurality of granular filter units arranged in the foregoing gas-liquid mixing tank to filter the water source in the gas-liquid mixing tank for the second time, and the filter units collide and squeeze with one another to allow more durable and homogeneous gas-liquid mixing, thus increasing the oxygen content in the water.

### BRIEF DESCRIPTION OF THE DRAWINGS

FIG. 1 is a schematic view showing a structure according to a first embodiment of the present invention.

FIG. 2 is a schematic view showing a structure according to a second embodiment of the present invention.

FIG. 3 is a schematic view showing a structure according to a third embodiment of the present invention.

FIG. 4 is a schematic view showing a structure according to a fourth embodiment of the present invention.

FIG. 5 is a schematic view showing a service condition according to a fourth embodiment of the present invention.

FIG. 6 is a microbubble water-treating device of the prior art.

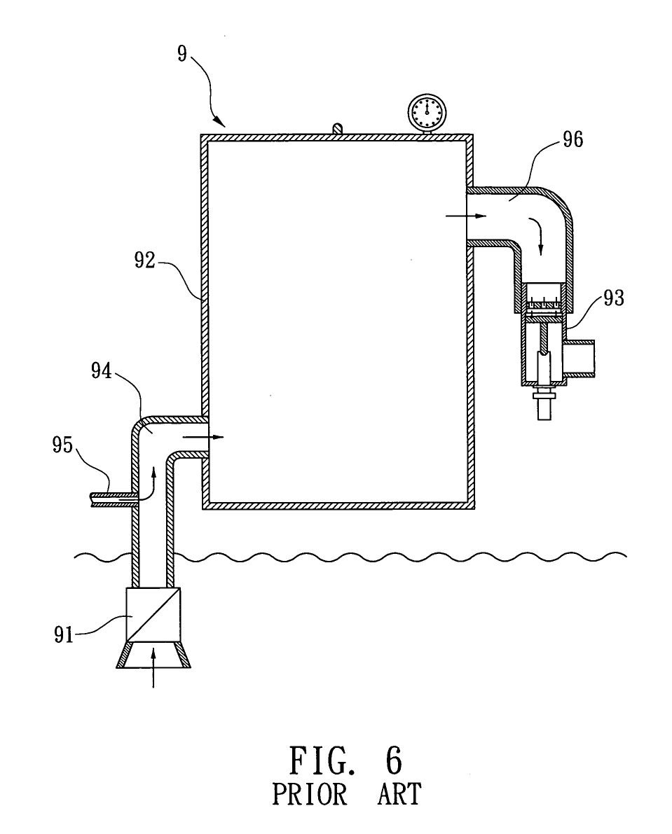

### DETAILED DESCRIPTION OF THE PREFERRED EMBODIMENTS

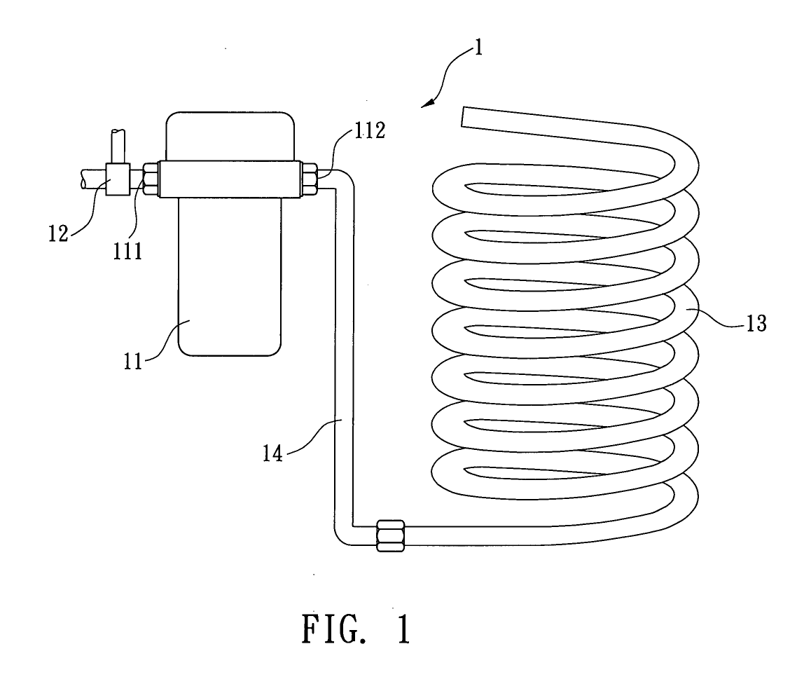

Referring to FIGS. 1 to 5, the structures according to the embodiments of the present invention are shown in the drawings, which are only illustrative and not intended to limit the scope of the present invention.

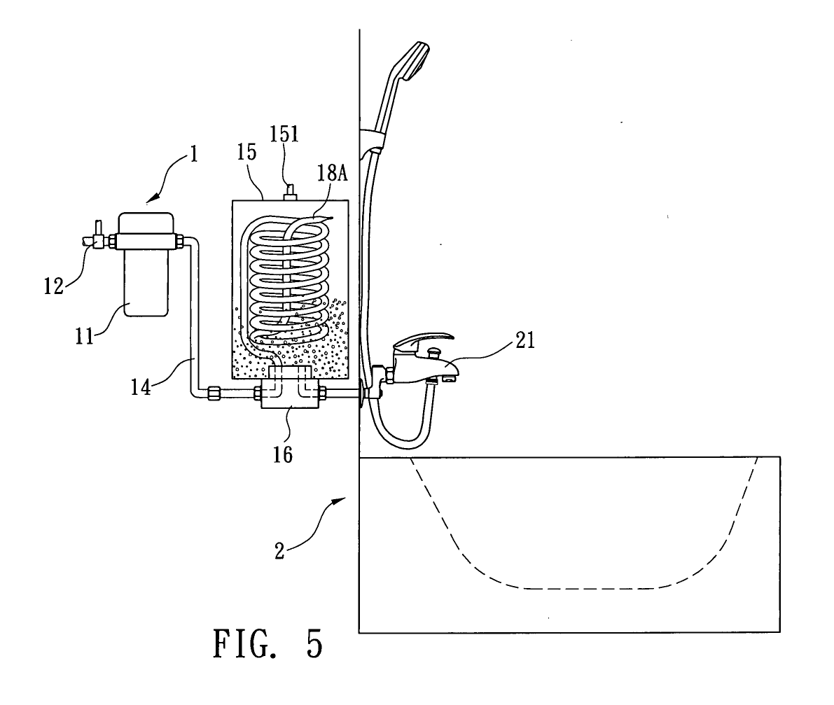

Referring to FIG. 1, there is a microbubble gas-liquid mixing device 1 shown, which is fitted and disposed in a sanitary fixture 2 as shown in FIG. 5, wherein the sanitary fixture 2 has at least one faucet 21 and the water source treated by the microbubble gas-liquid mixing device 1 can be introduced into the faucet 21, which is characterized in that:

The microbubble gas-liquid mixing device 1 comprises at least one pump 11, wherein the pump 11 has a water inlet end 111 and a water outlet end 112, and the water inlet end 111 communicates with the water outlet end 112, and at least a first gas inlet valve 12 is disposed at the water inlet end 111 and the water outlet end 112 communicates with a water supply channel 14, and air is introduced by means of the first gas inlet valve 12 and enters the pump 11 such that the pump 11 pressurizes the air and the water source to perform the gas-liquid mixing for the first time and generate a lot of fine oxygen-containing bubbles in the water source, and then transports the gas-liquid mixture from the water outlet end 112 to the water supply channel 14. In this embodiment, the pump 11 is, for example, a high-pressure pump, and the first gas inlet valve 12 is a back pressure valve. Subsequently, the water source containing many fine bubbles is prevented by the back pressure valve against the backflow of the water source and flows out of the first gas inlet valve 12.

A spiral tube 13 communicates with the water supply channel 14 and the water supply channel 14 contains the first gas-liquid mixed water source so that the water source flowing into the spiral tube 13 can be subjected to the second gas-liquid mixing action. Since the air and the water source swirl and mix within the spiral tube 13, the air can be mixed into the water more homogeneously. The oxygen-rich water source can be transported from the spiral tube 13.

In view of the above, the microbubble gas-liquid mixing device 1 in this embodiment can be directly connected to the sanitary fixture 2 by means of the spiral tube 13 in coordination with the pump 11 and the first gas inlet valve 12 and can discharge the water source filled with fine bubbles to achieve the effect of increasing the oxygen content in water. The spiral tube 13 can be directly mounted in a commercial filter element (not shown) for use.

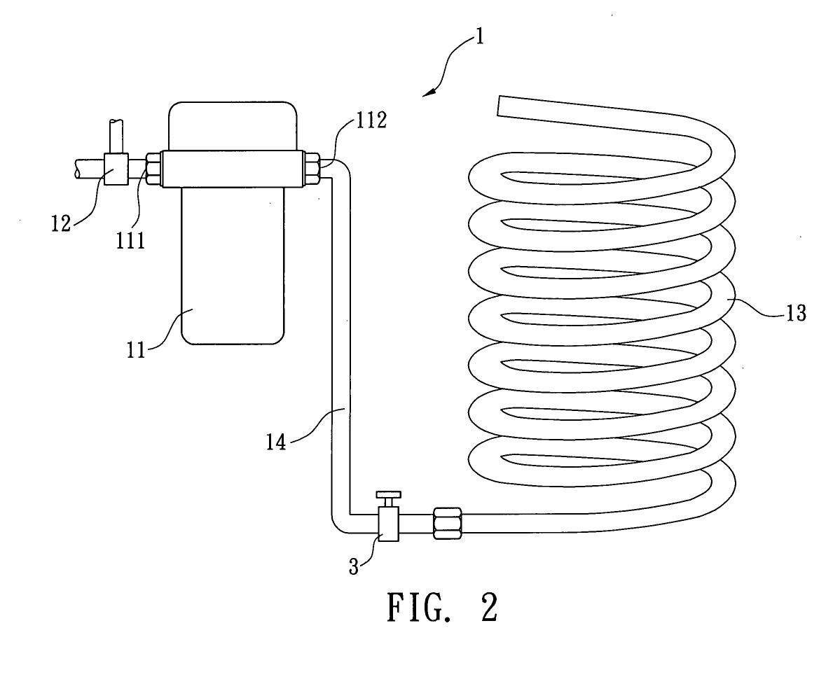

It is understood that the present invention still has other variants those are only different from some changes. Referring to FIG. 2, a second embodiment of the present invention is shown, wherein a regulating valve 3 is additionally disposed in the water supply channel 14 to regulate the water flow capacity from the water supply channel 14 to the spiral tube 13 and simultaneously regulate the outlet water pressure from the water supply channel 14 to the spiral tube 13. In this embodiment, the regulating valve 3 is a flow-limiting valve.

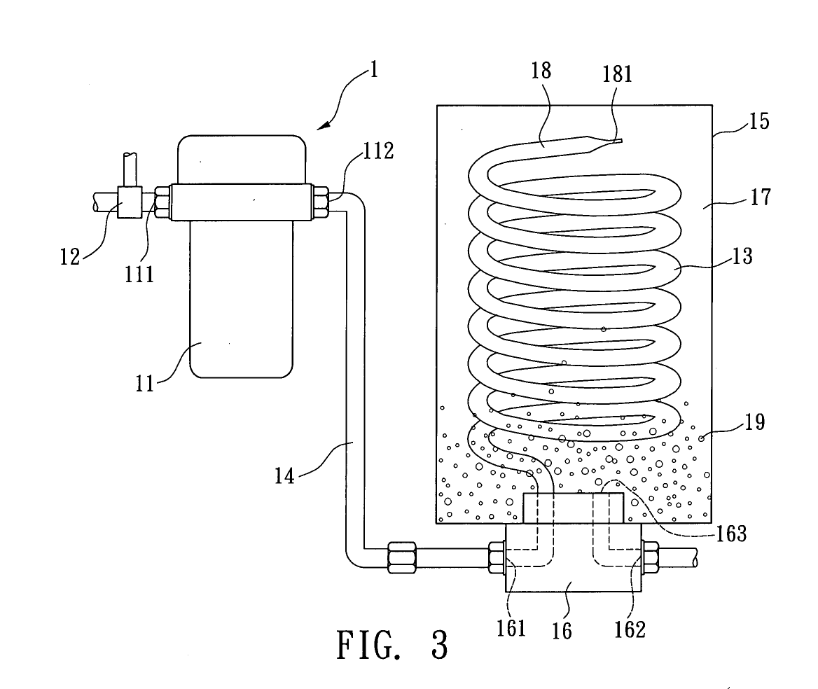

Referring to FIG. 3, a third embodiment of the present invention is shown, wherein the microbubble gas-liquid mixing device 1 is further provided with a gas-liquid mixing tank 15. The gas-liquid mixing tank 15 is provided at the bottom thereof with a gate valve seat 16 to form an enclosed space 17 within the gas-liquid mixing tank 15 and the spiral tube 13 is disposed in the enclosed space 17. In this embodiment, one end of the spiral tube 13 is disposed on the gate valve seat 16, and the gate valve seat 16 has a water inlet portion 161 and a water outlet portion 162, and the water inlet portion 161 communicates with the water supply channel 14 and the spiral tube 13 disposed on the gate valve seat 16. The water outlet portion 162 has a diversion hole 163 which communicates with the enclosed space 17 of the gas-liquid mixing tank 15.

The spiral tube 13 further comprises a high-pressure water outlet 18, and the high-pressure water outlet 18 has a flat open end 181 to deliver the water source as described in the above embodiments from the open end 181 of the high-pressure water outlet 18 after gas-liquid mixing in the spiral tube 13.

The open end 181 of the high-pressure water outlet 18 is flat-shaped so that the flow channel is convergent along the flow direction. Therefore, when the water source flows to the open end 181, the pressure will increase. This results in that the water stream is ejected from the high-pressure water outlet 18 in the form of high-pressure spray and impacts on the one side of the enclosed space 17 of the gas-liquid mixing tank 15. In this embodiment, the high-pressure water outlet 18 corresponds to one side of the head of the gas-liquid mixing tank 15.

Furthermore, water molecules would change their direction of movement while colliding with the gas-liquid mixing tank 15 so that the direction of the high-pressure water stream impacting on the gas-liquid mixing tank 15 will be changed and turbulent flows will occur in the gas-liquid mixing tank 15 to advantageously perform the third gas-liquid mixing. Numerous finer bubbles will form in the water source after gas-liquid mixing.

Additionally, in order to improve the effects of water purification and gas-liquid mixing, a plurality of granular filter units 19 are positioned in the gas-liquid mixing tank 15 to filter the water source in the gas-liquid mixing tank 15 once again, and the filter units 19 collide and squeeze with one another to allow more durable and homogeneous gas-liquid mixing, thus increasing the oxygen content in the water.

The foregoing gas-liquid mixed water source for three times has contained a large amount of fine bubbles, that is, a large amount of air has been mixed into the water source and increases the oxygen content in the water so that the water source can be guided by the diversion hole 163 of the gate valve seat 16 to the water outlet portion 162 and drained.

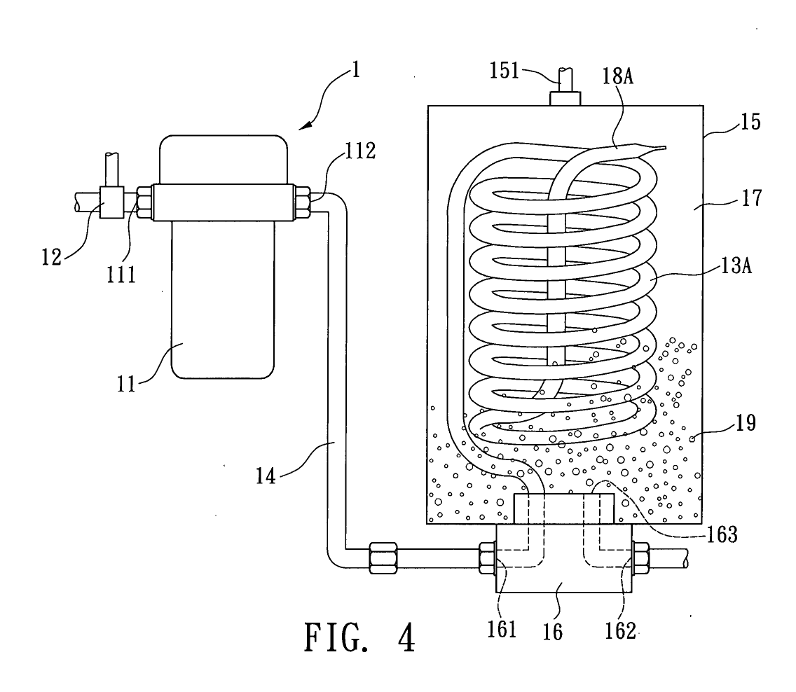

Next, referring to FIGS. 4 and 5, a fourth embodiment of the present invention is shown, which differs from the foregoing third embodiment in that the high-pressure water outlet 18A passes through out of the region surrounded by the spiral tube 13A, and the gas-liquid mixing tank 15 is further provided with a second gas inlet valve 151. In this embodiment, the second gas inlet valve 151 is, for example, a back pressure valve. Air is introduced by means of the second gas inlet valve 151 for the second time and enters the enclosed space 17 to perform the fourth gas-liquid mixing. The oxygen content in water would be further increased by the introduction of air through the second gas inlet valve 151.

From the above embodiments, the advantages of the present invention are as follows: air and a water source simultaneously enter the pump, and the pump pressurizes the air and the water source for mixing and enables the pressurized gas-liquid mixture to enter a spiral tube for gas-liquid mixing once again and then to pass through a high-pressure water outlet and to be ejected into the gas-liquid mixing tank in the form of high-pressure spray. The arrangement of the filter units in coordination with the first and second gas inlet valves can remove the impurities from water and allow the air and the water source to mix more homogeneously. Not only does the oxygen content in water markedly increase, but also the mixed water source contains a large amount of fine bubbles.

What has been described above is the preferred embodiment of the present invention only, and it is not intended to limit the scope of the present invention. Various equivalent changes and alternatives to the present invention can be made to the elements of the present invention without departing from the spirit and scope of this present invention. Accordingly, all such equivalent changes and alternatives should be included within the scope of the appended claims.

It will be appreciated and understood by those skilled in the art from the above detailed description that the present invention can achieve the foregoing objective indeed, and the application for a patent is duly filed accordingly.

I claim:

1. A microbubble gas-liquid mixing device, which is fitted and disposed in a sanitary fixture, wherein the sanitary fixture has at least one faucet and the water source treated by the microbubble gas-liquid mixing device is introduced into the faucet, characterized in that:
the microbubble gas-liquid mixing device comprises at least one pump, wherein the pump has a water inlet end and a water outlet end, and the water inlet end communicates with the water outlet end, and at least a first gas inlet valve is disposed at the water inlet end and the water outlet end communicates with a water supply channel, and air is introduced by means of the first gas inlet valve and enters the pump such that the pump pressurizes the air and the water source for gas-liquid mixing and then transports the mixture from the water outlet end to the water supply channel; and
a spiral tube, which communicates with the water supply channel such that the gas-liquid mixed water source contained in the water supply channel flows into the spiral tube for gas-liquid mixing once again allowing the air and the water source to swirl and mix within the spiral tube and to output the oxygen-rich water source from the spiral tube.

2. The microbubble gas-liquid mixing device as described in claim 1, wherein the pump is a high-pressure pump.

3. The microbubble gas-liquid mixing device as described in claim 1, wherein the first gas inlet valve is a back pressure valve.

4. The microbubble gas-liquid mixing device as described in claim 1, wherein a regulating valve is additionally disposed in the water supply channel to regulate the water flow capacity from the water supply channel to the spiral tube and simultaneously regulate the outlet water pressure from the water supply channel to the spiral tube.

5. The microbubble gas-liquid mixing device as described in claim 4, wherein the regulating valve is a flow-limiting valve.

6. The microbubble gas-liquid mixing device as described in claim 1, wherein the microbubble gas-liquid mixing device is further provided with a gas-liquid mixing tank, which is provided with a gate valve seat to form an enclosed space within the gas-liquid mixing tank and the spiral tube is disposed in the enclosed space, and the gate valve seat has a water inlet portion and a water outlet portion, and the water inlet portion communicates with the water supply channel and the spiral tube.

7. The microbubble gas-liquid mixing device as described in claim 6, wherein the gate valve seat is disposed on the bottom of the gas-liquid mixing tank.

8. The microbubble gas-liquid mixing device as described in claim 6, wherein one end of the spiral tube is disposed on the gate valve seat.

9. The microbubble gas-liquid mixing device as described in claim 6, wherein the gate valve seat has a diversion hole which communicates with the enclosed space of the gas-liquid mixing tank.

10. The microbubble gas-liquid mixing device as described in claim 1, wherein the spiral tube further comprises a high-pressure water outlet, and the high-pressure water outlet has a flat open end to deliver the water source from the open end of the high-pressure water outlet of the spiral tube.

11. The microbubble gas-liquid mixing device as described in claim 6, wherein the spiral tube further comprises a high-pressure water outlet, and the high-pressure water outlet has a flat open end to deliver the water source from the open end of the high-pressure water outlet of the spiral tube.

12. The microbubble gas-liquid mixing device as described in claim 11, wherein the high-pressure water outlet corresponds to one side of the head of the gas-liquid mixing tank.

13. The microbubble gas-liquid mixing device as described in claim 6, wherein the gas-liquid mixing tank is further provided with a second gas inlet valve, and air is introduced by means of the second gas inlet valve for the second time and enters the enclosed space for gas-liquid mixing.

14. The microbubble gas-liquid mixing device as described in claim 13, wherein the second gas inlet valve is a back pressure valve.

15. The microbubble gas-liquid mixing device as described in claim 6, wherein a plurality of granular filter units are positioned in the gas-liquid mixing tank to filter the water source in the gas-liquid mixing tank once again, and the filter units collide and squeeze with one another to allow more durable and homogeneous gas-liquid mixing, thus increasing the oxygen content in water.
